(19) United States
(12) Patent Application Publication
(10) Pub. No.: US 2013/0153418 A1
(43) Pub. Date: Jun. 20, 2013

(54) SENSING DEVICE AND FABRICATING METHOD THEREOF

(71) Applicants: Lung-Tai Chen, Kaohsiung City (TW); Chin-Sheng Chang, Tainan City (TW); Jing-Yuan Lin, New Taipei City (TW); Chun-Hsun Chu, Tainan City (TW)

(72) Inventors: Lung-Tai Chen, Kaohsiung City (TW); Chin-Sheng Chang, Tainan City (TW); Jing-Yuan Lin, New Taipei City (TW); Chun-Hsun Chu, Tainan City (TW)

(73) Assignee: Industrial Technology Research Institute, Hsinchu (TW)

(21) Appl. No.: 13/443,902

(22) Filed: Apr. 11, 2012

(30) Foreign Application Priority Data
Dec. 16, 2011 (TW) 100146903
Mar. 16, 2012 (TW) 101109089

(51) Int. Cl. G01N 27/30; B32B 37/14; B32B 37/02

(52) U.S. Cl. 204/431; 156/182

(57) ABSTRACT

A sensing device is provided. A suction port of a chamber is sealed by using a gas sealing layer with a gas sealing filter. The gas sealing filter has a plurality of one-way passes. The one-way passes have a width in a range of several nanometers to several hundred nanometers. A gas molecular exhausts to the outside of the chamber through the one-way passes. Owing to preventing the material of gas sealing layer from flowing into the chamber by the gas sealing filter, superior sealing performance is achieved as compared to those adopting solder or sealing material, thereby facilitating control of the condition in the chamber.

### CROSS-REFERENCE TO RELATED APPLICATION

This application claims the priority benefit of Taiwan application serial no. 100146903, filed on Dec. 16, 2011 and Taiwan application serial no. 101109089, filed on Mar. 16, 2012. The entirety of each of the above-mentioned patent applications is hereby incorporated by reference herein and made a part of this specification.

### TECHNICAL FIELD

The disclosure generally relates to a sensing device and a fabricating method thereof.

### BACKGROUND

Generally speaking, a sensing element in a microelectromechanical sensing device shall operate in a sensing chamber with the specific condition, so as to ensure stable operation of the sensing element and obtain an accurate sensing output result. Based on design requirements of sensing mechanisms of different sensing devices, the condition in sensing chambers for accommodating sensing elements is different accordingly. For example, for some sensing devices, an effect of vibration damping of a sensing element on a vibration frequency and a noise ratio of a sensing signal is required to be taken into account, so that sensing elements (for example, a resonant magnetic field sensor, a resonator, a Radio Frequency (RF) switch, a micro bolometer, and a gyroscope) are disposed in a gastight chamber of a high negative pressure or being vacuum to operate, so as to reduce energy losses caused by air damping.

In the most sensing device in the related art, passes of a chamber to the outside are usually filled by reflowing solder or depositing a filling material, so as to form a sealed chamber. Another conventional method is that a getter layer is disposed inside a chamber of a sensing device, so as to lock excessive gas molecules in the chamber of the sensing device in the getter layer, thereby increasing the degree of vacuum of the chamber of the sensing device.

### SUMMARY

The disclosure provides a sensing device, which includes a housing, a gas sealing filter, a gas sealing layer and a sensing element. The housing includes at least one exhaust vent, the exhaust vent penetrates through a first surface and a second surface of the housing. The gas sealing filter at least covers the exhaust vent, the gas sealing filter includes at least one pass having a section in the shape of an irregular curve, the pass penetrates through the gas sealing filter, and a width of the pass is in a range of several nanometers to several hundred nanometers. The gas sealing layer at least covers the exhaust vent, a part of the gas sealing filter and a part of the pass. The sensing element is disposed in the housing.

The sensing device further includes a rigid support member. The rigid support member is disposed between the housing and the gas sealing filter, the rigid support member at least covers a part of the exhaust vents, the rigid support member includes at least one opening, the opening penetrates through the rigid support member, and the exhaust vent, the pass and the opening are in communication with one another.

The disclosure provides a fabricating method, which includes the following steps. A sensing element is formed on a first substrate. At least one exhaust vent is formed on a second substrate, where the exhaust vent penetrates through a first surface and a second surface of the second substrate. A gas sealing filter is formed on the second substrate, where the gas sealing filter includes at least one pass having a section in the shape of an irregular curve, the pass penetrates through the gas sealing filter, and a width of the pass is in a range of several nanometers to several hundred nanometers. The second substrate is bonded on the first substrate, where at least one of the first substrate and the second substrate has a recessed portion, and a chamber is formed between the second substrate and the first substrate. A gas sealing layer is formed on the second substrate, so as to seal the chamber, where the gas sealing layer at least covers the exhaust vent, a part of the gas sealing filter and a part of the pass.

The fabricating method of a sensing device provided further includes following steps. A rigid support member is formed between the second substrate and the gas sealing filter, where the rigid support member at least covers the exhaust vent, the rigid support member has an opening, the opening penetrates through the rigid support member, and the exhaust vent, the pass and the opening are in communication with one another.

In order to make the aforementioned features and advantages of the disclosure more comprehensible, embodiments are described in detail below with the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic view of a sensing device according to a first embodiment of the disclosure.

FIG. 1B is a schematic view of a sensing device according to a second embodiment of the disclosure.

FIG. 1C is a schematic view of a sensing device according to a third embodiment of the disclosure.

FIG. 1D is a schematic view of a sensing device according to a fourth embodiment of the disclosure.

FIG. 2A is a photograph of a section of a gas sealing filter according to the disclosure.

FIG. 2B is a photograph of a section of a gas sealing filter deposited with a gas sealing layer according to the disclosure.

FIG. 3A to FIG. 3D are in sequence flow charts of fabricating the sensing device according to the fourth embodiment of the disclosure.

FIG. 4 is a process machine table according to embodiments of the disclosure.

### DESCRIPTION OF THE EMBODIMENTS

Reference will now be made in detail to the embodiments of the disclosure, examples of which are illustrated in the accompanying drawings. Wherever possible, the same reference numbers are used in the drawings and the description to refer to the same or like parts.

It should be noted that numerals of the same or similar elements may be the same in embodiments of the disclosure.

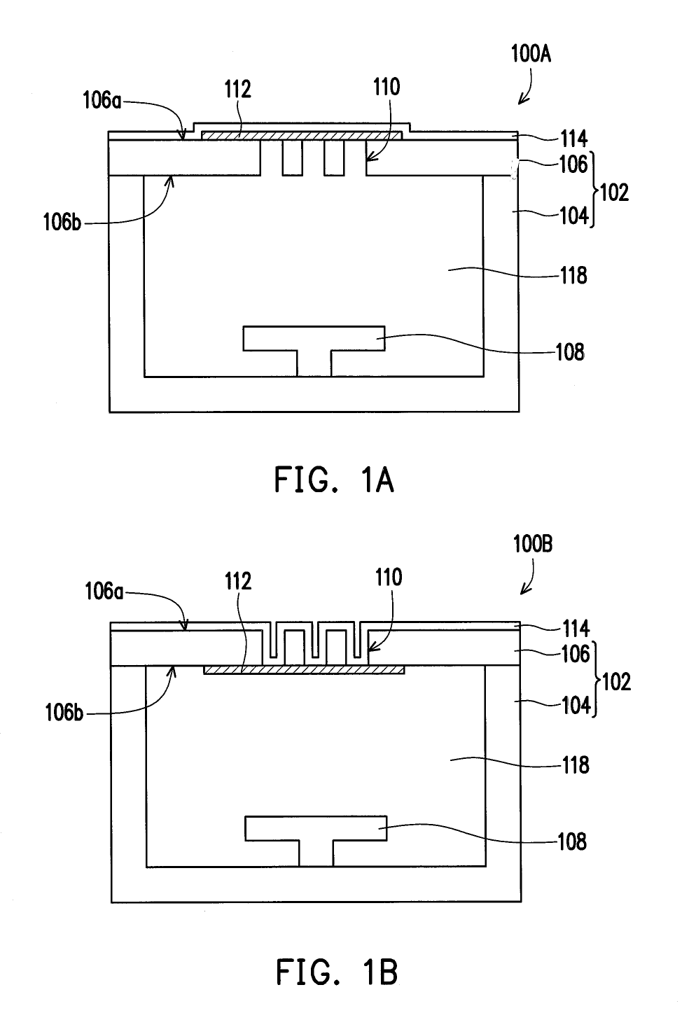

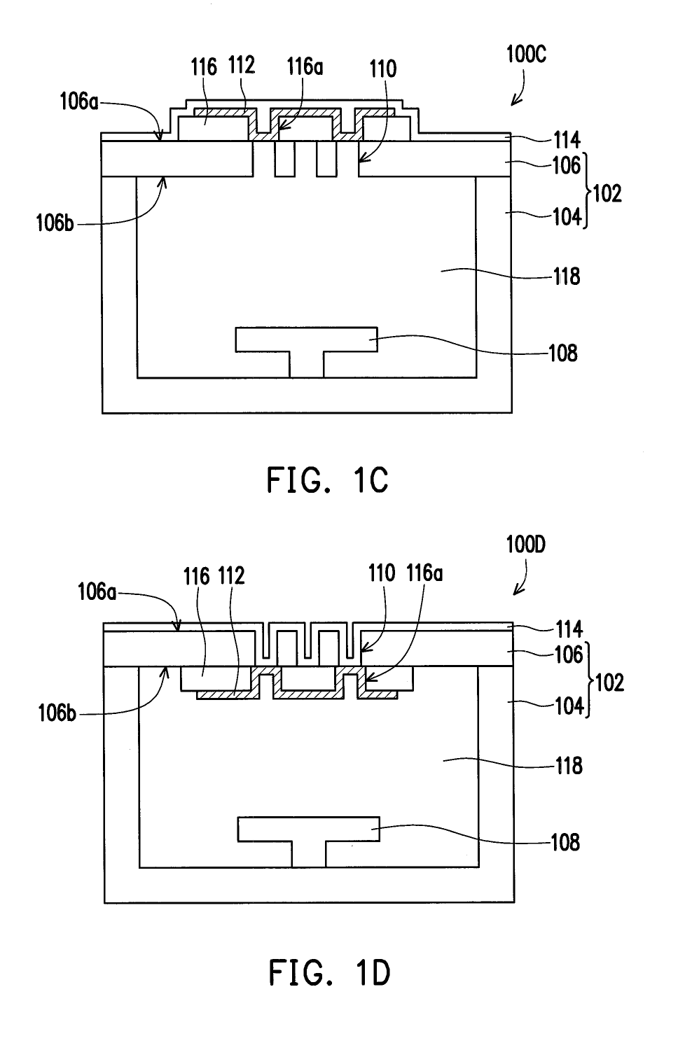

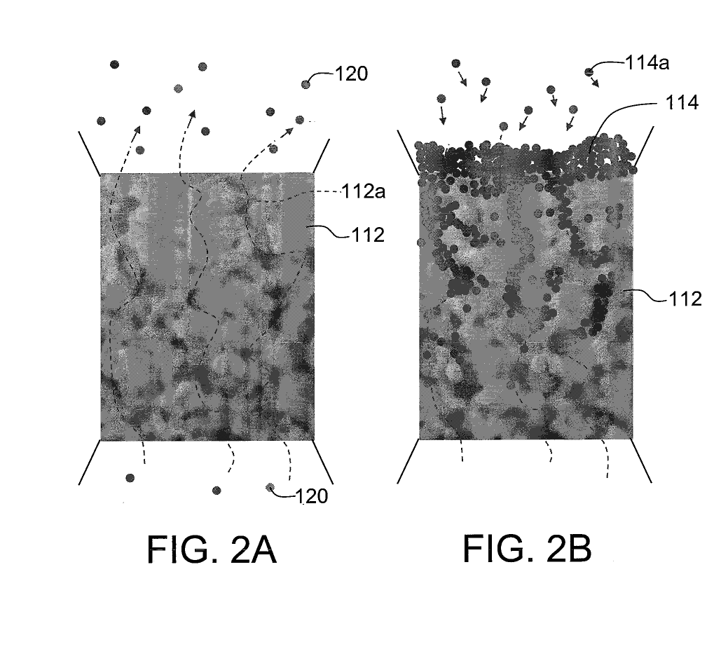

FIG. 1A illustrates a sensing device according to a first embodiment of the disclosure. FIG. 2A is a photograph of a section of a gas sealing filter according to the disclosure. FIG. 2B is a photograph of a section of a gas sealing filter deposited with a gas sealing layer according to the disclosure.

As shown in FIG. 1A, a sensing device 100A includes a housing 102, a gas sealing filter 112, a gas sealing layer 114 and a sensing element 108.

The housing 102 has a plurality of exhaust vents 110, and the exhaust vents 110 penetrate through a first surface 106a and a second surface 106b of the housing 102.

The housing 102 is, for example, formed by a first substrate 104 and a second substrate 106. As shown in following embodiments of the disclosure, the first surface 106a and the second surface 106b are the first surface 106a and the second surface 106b of the second substrate 106, for example. The material of the first substrate 104 and the second substrate 106 is, for example, a silicon substrate. The first substrate 104 has, for example, a recessed portion. The second substrate 106 covers, for example, the first substrate 104. A chamber 118 is formed between the second substrate 106 and the first substrate 104. The second surface 106b of the housing 102 faces the chamber 118. The first surface 106a and the second surface 106b are opposite sides of the housing 102. In the embodiment, the exhaust vents 110 are, for example, disposed on the second substrate 106. The exhaust vents 110 may be disposed at any position of the housing 102, for example, at a top portion or a side wall of the housing 102. In the embodiment, illustration is provided by using an example in which the first substrate 104 has a recessed portion (with a cross-section in the shape of “ [symbol] ”) and the second substrate 106 is in the shape of a flat plate. In the another embodiment, alternately the first substrate 104 may be in the shape of a flat plate, and the second substrate 106 may have a recessed portion (with a cross-section in the shape of “ [symbol] ”); and alternately the first substrate 104 may have a recessed portion (with a cross-section in the shape of “ [symbol] ”), and the second substrate 106 may have a recessed portion (with a cross-section in the shape of “ [symbol] ”). That is, the disclosure does not limit the shape or formation of the first substrate 104 and the second substrate 106, if the chamber 118 for accommodating the sensing element can be formed between the first substrate 104 and the second substrate 106. In the another embodiment, a plurality of recessed portions is formed in the first substrate 104, and the first substrate 104 is covered by the second substrate 106. A plurality of exhaust vents 110 corresponding to each of the recessed portions of the first substrate 104 is formed on the second substrate 106. One or more sensing elements which are the same or different form each other may be disposed in the recessed portion. The recessed portions may be arranged in a manner of row, column or array. These kinds of design can be made to the structure of the disclosure without departing from the scope or spirit of the disclosure, and the detail description is omitted.

The gas sealing filter 112 at least covers the exhaust vents 110. In the embodiment, the gas sealing filter 112 is disposed on the first surface 106a of the housing 102. In the embodiment, the gas sealing filter 112 is, for example, disposed on the first surface 106a of the second substrate 106 of the housing 102. As shown in FIG. 2A, the gas sealing filter 112 has passes 112a each having a section in the shape of an irregular curve. The passes 112a penetrate through the gas sealing filter 112. Each passes 112a have a width, for example, in a range of several nanometers to several hundred nanometers. The gas sealing filter 112 has the passes 112a each having a section in the shape of an irregular curve, so that a gas molecule 120 inside the chamber 118 may exhaust to the outside of the chamber 118 through the passes 112a. The gas sealing filter 112 is a one-way gas sealing film. The one-way gas sealing film has the irregularly curved continuous passes 112a penetrating through the whole film thickness, so that excessive outgassing gas molecule groups emitted during a conventional gas sealing bonding process of the chamber can be completely extracted/exhausted to the outside of the whole chamber 118 through the irregularly curved continuous passes 112a of the one-way gas sealing film by an evacuation device, for example, a vacuum pump, so as to enable the chamber 118 achieve a high vacuum. Meanwhile, during loading of a gas sealing layer material in a following coating process of the gas sealing layer 114, the gas sealing layer material may initially deposit and block the nanometer-scale irregularly curved continuous passes therein due to a curing action of a molecular reaction, so that the coating layer material does not enter the vacuumed empty sensing chamber through the one-way gastight micro-nano sealing film.

The material of the gas sealing filter 112 is, for example, metal, ceramic, or polymer. In the disclosure, any material having the irregularly curved continuous passes 112a penetrating through the whole film thickness can be used as the gas sealing filter 112, so that the material thereof is not limited. In an embodiment of the disclosure, the gas sealing filter 112 is, for example, metal having micropores, and a fabricating method thereof is, for example, to provide a bi-metal alloy. Then, dealloying is performed on the bi-metal alloy, so that single-component metal is left. For example, when a platinum-copper alloy piece is used to manufacture the gas sealing filter 112, the dealloying is performed to remove the component of copper or platinum, so as to form a copper piece or a platinum piece having the passes 112a each with the section in the shape of an irregular curve.

The gas sealing layer 114 at least covers the exhaust vents 110, the gas sealing filter 112, and a part of the passes 112a. As shown in FIG. 2B, when the gas sealing layer 114 is being formed and during the loading of a gas sealing layer material 114a, the gas sealing layer material 114a performs the curing action due to reaction and diffusion of molecules, so as to initially deposit and finally block the irregularly curved continuous passes 112a therein or near open ends of the passes of the exhaust ports. That is, the gas sealing layer material 114a may fill a part of the passes 112a. The gas sealing layer material 114a does not enter the vacuumed chamber 118 through the one-way gas sealing film (the gas sealing filter 112), so as to provide a gastight sensing element structure having high degree of vacuum. The material of the gas sealing layer 114 may be metal or a metal oxide, such as gold, platinum, copper, aluminum, silica, silicon nitride, and silicon oxynitride. A forming method of the gas sealing layer 114 is, for example, a physical vapor deposition method or a chemical vapor deposition method.

As shown in FIG. 1A, the sensing element 108 is disposed in the chamber 118. The sensing element 108 may be a resonant magnetic field sensor, a resonator, an RF switch, a micro bolometer, or a gyroscope.

FIG. 1B illustrates a sensing device according to a second embodiment of the disclosure. As shown in FIG. 1B, a gas sealing filter 112 of a sensing device 100B is disposed on a second surface 106b of a housing 102 and covers the exhaust vents 110. In the embodiment, the gas sealing filter 112 is, for example, disposed on the second surface 106b of the second substrate 106 of the housing 102. A gas sealing layer 114 at least covers exhaust vents 110, a part of the gas sealing filter 112 and a part of passes 112a, and seals the exhaust vents 110. In the embodiment, the method for forming the gas sealing layer 114 is the same as shown in FIGS. 1A-2B.

FIG. 1C illustrates a sensing device according to a third embodiment of the disclosure. As shown in FIG. 1C, a gas sealing filter 112 of a sensing device 100C is disposed on a first surface 106a of a housing 102. In the embodiment, the gas sealing filter 112 is, for example, disposed on the first surface 106a of the second substrate 106 of the housing 102. A rigid support member 116 is disposed between the housing 102 and the gas sealing filter 112. That is, the rigid support member 116 is disposed on the first surface 106a of the housing 102. The rigid support member 116 is used to support the gas sealing filter 112, and can improve adherence of the housing 102 and the gas sealing filter 112. The rigid support member 116 at least covers a part of the exhaust vents 110, and the rigid support member 116 has one or more openings 116a. The opening 116a penetrates through the rigid support member 116. Before a gas sealing layer 114 is formed, the exhaust vents 110, passes 112a of the gas sealing filter 112 and the opening 116a of the rigid support member 116 are in communication with one another, so that a gas in the chamber 118 can be extracted/exhausted to the outside. The material of the rigid support member 116 may be a metal material or a metal oxide material.

The gas sealing layer 114 at least covers the rigid support member 116, the gas sealing filter 112, and a part of the passes 112a, and seal the exhaust vents 110.

FIG. 1D illustrates a sensing device according to a fourth embodiment of the disclosure. As shown in FIG. 1D, a gas sealing filter 112 of a sensing device 100D is disposed on a second surface 106b of a housing 102. In the embodiment, the gas sealing filter 112 is, for example, disposed on the second surface 106b of the second substrate 106 of the housing 102. A rigid support member 116 is disposed between the housing 102 and the gas sealing filter 112. That is, the rigid support member 116 is disposed on the second surface 106b of the housing 102. The gas sealing layer 114 at least covers exhaust vents 110, a part of the gas sealing filter 112, a part of the rigid support member 116 and a part of passes 112a. In the sensing device of the disclosure, the sensing chamber of ultrahigh vacuum is mainly formed by using the gas sealing layer 114 with the gas sealing filter 112. The gas sealing filter 112 has the one-way passes each having the width in the range of several nanometers to several hundred nanometers. The one-way passes refer to the following. Excessive exhaust gas molecule groups emitted during the conventional gas sealing bonding process of the sensing chamber can be completely extracted/exhausted to the outside of the whole sensing chamber through the one-way passes, so as to enable the sensing chamber to be highly vacuum. Meanwhile, during the loading of the gas sealing layer material in a following coating process of the gas sealing layer 114, the gas sealing layer material may initially deposit and finally block the nanometer-scale irregularly curved continuous passes therein due to a curing action of a molecular reaction, so that the gas sealing layer material does not enter the vacuumed empty sensing chamber through the one-way passes, thereby providing a gastight sensing chamber structure having high degree of vacuum. In the disclosure, the gas molecule exhausts to the outside of the chamber 118 through the one-way passes, and the gas sealing filter 112 may also prevent the gas sealing layer material from flowing into the chamber, so that superior sealing performance is achieved as compared to those adopting conventional solder or a sealing material with a loose structure, thereby facilitating control of the condition in the chamber 118. Further, the sensing device of the disclosure is simple in structure, and easy to manufacture, thereby increasing the process yield and decreasing the fabricating cost.

In the sensing device of the disclosure, the rigid support member 116 is selectively disposed between the housing 102 and the gas sealing filter 112, and the rigid support member 116 can support the gas sealing filter 112 and improve the adherence of the housing 102 and the gas sealing filter 112.

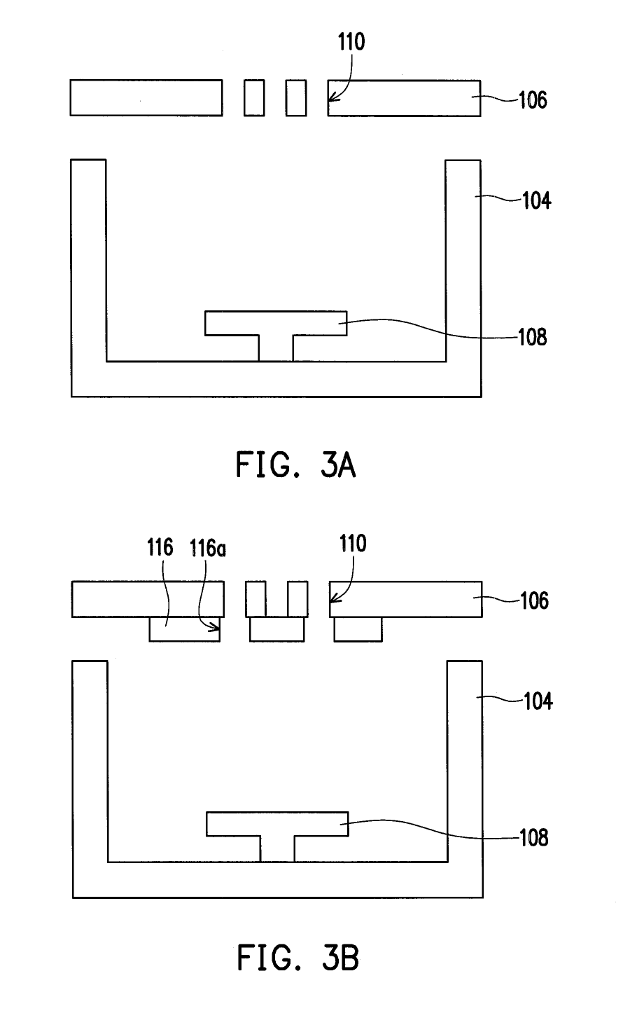

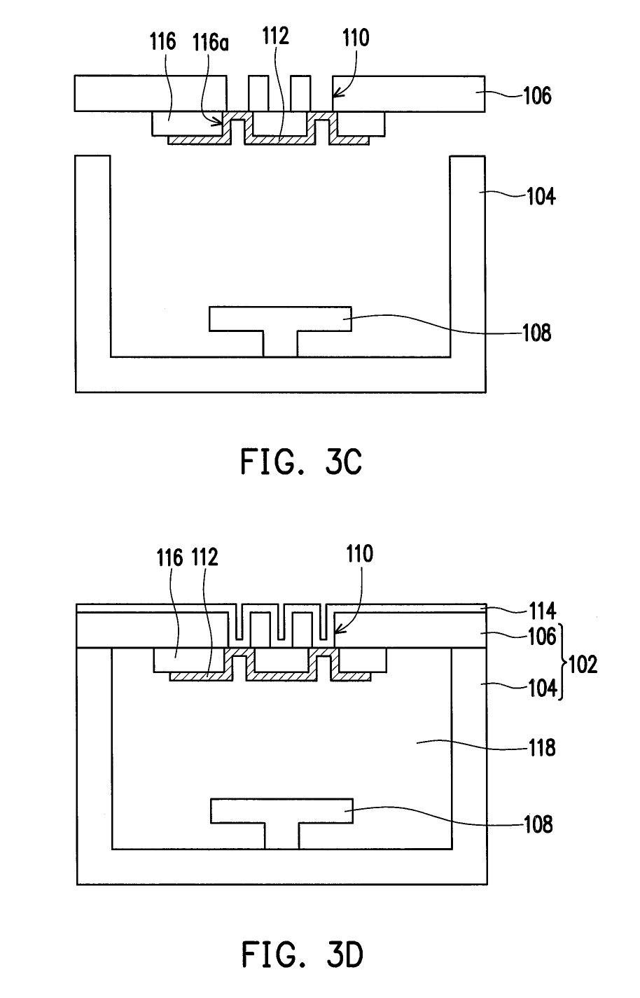

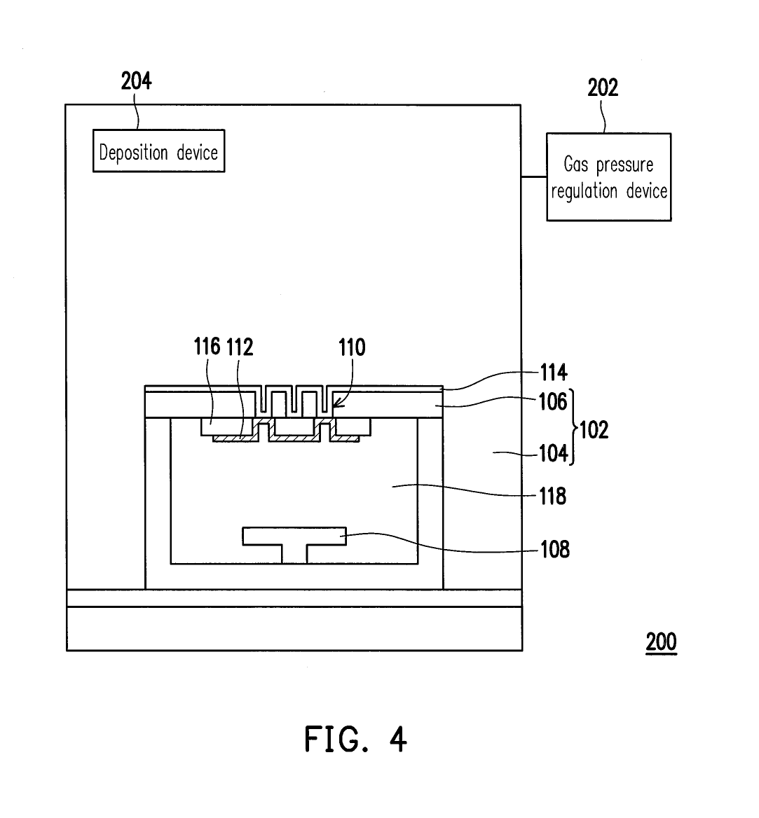

FIG. 3A to FIG. 3D are in sequence flow charts of fabricating the sensing device according to the fourth embodiment of the disclosure. FIG. 4 is a process machine table according to the embodiments of the disclosure.

Referring to FIG. 3A, a first substrate 104 and a second substrate 106 are prepared. A sensing element 108 is formed in a recessed portion of the first substrate 104. Exhaust vents 110 are formed on the second substrate 106. The exhaust vents 110 penetrate through the second substrate 106.

Referring to FIG. 3B, a rigid support member 116 is formed on the second substrate 106. The rigid support member 116 at least covers the exhaust vents 110, and the rigid support member 116 has an opening 116a. The opening 116a penetrates through the rigid support member 116. A part of the exhaust vents 110 are in communication with a part of the opening 116a. A chip bonding technology is used to bond the second substrate 106 and the rigid support member 116. The chip bonding technology may be a direct bonding technology including anodic bonding, diffusion bonding, and plasma enhanced bonding, or an indirect bonding technology using an intermediate bonding layer as a bonding medium.

Referring to FIG. 3C, a gas sealing filter 112 is formed on the second substrate 106. The gas sealing filter 112 has passes 112a each having a section in the shape of an irregular curve. The passes 112a penetrate through the gas sealing filter 112, and the passes 112a each have a width in the range of several nanometers to several hundred nanometers. The gas sealing filter 112 at least covers the exhaust vents 110 of the second substrate 106 and the opening 116a of the rigid support member 116. The material of the gas sealing filter 112 is, for example, metal, ceramic, or polymer. In the embodiment, illustration is provided by using an example in which the gas sealing filter 112 is metal having micropores. A fabricating method of the gas sealing filter 112 is as follows. First, the second substrate 106 is coated with a bi-metal alloy layer. Then, dealloying is performed on the bi-metal alloy, and an etchant is used to remove a component metal of the bi-metal alloy, so as to form a copper layer or a platinum layer having the passes each having a section in the shape of an irregular curve. In another embodiment, alternatively, the gas sealing filter 112 may be manufactured first, and then the chip bonding technology is used to bond the second substrate 106 and the gas sealing filter 112.

Referring to FIG. 3D, the chip bonding technology is used to bond the second substrate 106 and the first substrate 104. The chip bonding technology may be a direct bonding technology including anodic bonding, diffusion bonding, and plasma enhanced bonding, or an indirect bonding technology using an intermediate bonding layer as a bonding medium. In the embodiment, the gas sealing filter 112 faces the sensing element 108, the second substrate 106 and the first substrate 104 are bonded, and a chamber 118 is formed between the second substrate 106 and the first substrate 104. Then, a gas sealing layer 114 is formed on the first surface 106a of the second substrate 106 to seal the chamber 118. The gas sealing layer 114 at least covers the exhaust vents 110 and a part of the gas sealing filter 112.

When the gas sealing layer 114 is being formed, a process machine table shown in FIG. 4 may be employed. As shown in FIG. 4, a gas pressure regulation device 202 and a deposition device 204 are disposed in a machine table 200 of the embodiment. After being bonded, the second substrate 106 and the first substrate 104 are placed in the machine table 200. The gas pressure regulation device 202 is used to control the condition in the machine table 200, so as to adjust the pressure and components of a gas in the machine table 200. When the pressure in the machine table 200 reaches a set value, the deposition device 204 is used to form the gas sealing layer 114. The gas pressure regulation device 202 includes a evacuation device, a controller, pressure detector and etc. The chamber is evacuated to a preset pressure by the evacuation device of the gas pressure regulation device 202, and the pressure of the chamber is detected by the pressure detector. When the preset pressure is reached, the controller receives a signal (e.g., degree of vacuum) form the pressure detector and operates the deposition device 204 to deposit a material of gas sealing layer on the gas sealing filter 112. The material of gas sealing layer is deposited on the passes of gas sealing filter 112 to form a gas sealing layer.

In the method, if the gas sealing filter 112 has the back thereof facing the sensing element 108, the second substrate 106 and the first substrate 104 are bonded, and the chamber 118 is formed between the second substrate 106 and the first substrate 104. Then, the gas sealing layer 114 is formed, so as to manufacture the sensing device according to the third embodiment.

In the method, if the step of fabricating the rigid support member 116 is saved, and the gas sealing filter 112 has the back thereof facing the sensing element 108, the second substrate 106 and the first substrate 104 are bonded, and the chamber 118 is formed between the second substrate 106 and the first substrate 104. Then, the gas sealing layer 114 is formed, so as to fabricate the sensing device according to the first embodiment.

In the method, if the step of fabricating the rigid support member 116 is saved, and the gas sealing filter 112 faces the sensing element 108, the second substrate 106 and the first substrate 104 are bonded, and the chamber 118 is formed between the second substrate 106 and the first substrate 104. Then, the gas sealing layer 114 is formed, so as to fabricate the sensing device according to the second embodiment.

In the fabricating method of the sensing device of the disclosure, the exhaust vents 110 of the sealed chamber 118 are sealed by using the gas sealing layer 114 with the gas sealing filter 112. The condition in the chamber 118 may be determined by a process environment when the gas sealing layer 114 is being formed. When the gas sealing layer 114 is being formed, the gas sealing filter 112 may prevent the gas sealing layer material from flowing into the chamber 118. In addition, the fabricating method of the disclosure has a simple fabricating process, thereby increasing the process yield and decreasing the fabricating cost.

The disclosure may also be applicable to a chamber structure in which a plurality of chambers of different conditions is integrated on the same substrate (for example, a chip).

In view of the above, in the disclosure, the sensing chamber of ultrahigh vacuum is formed by using the gas sealing layer with the gas sealing filter. The gas sealing filter has the one-way passes each having the width in the range of several nanometers to several hundred nanometers. The gas molecule exhausts to the outside of the chamber through the one-way passes. The gas sealing filter may also prevent the gas sealing layer material from flowing into the chamber, so that excellent sealing performance may be achieved as compared to those adopting the solder or sealing material with a loose structure, thereby facilitating control of the condition in the chamber. Further, the sensing device of the disclosure is simple in structure, and easy to manufacture, thereby increasing the process yield and decreasing the fabricating cost.

In the disclosure, the opening of the sealed chamber is sealed by using the gas sealing layer with the gas sealing filter, and the condition in the chamber may be determined by the process environment when the gas sealing layer is being formed. In addition, the fabricating method of the disclosure has a simple fabricating process, thereby increasing the process yield and decreasing the fabricating cost.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A sensing device, comprising:
a housing, comprising at least one exhaust vent, wherein the exhaust vent penetrates through a first surface and a second surface of the housing;
a gas sealing filter, at least covering the exhaust vent, wherein the gas sealing filter comprises at least one pass having a section in the shape of an irregular curve, the pass penetrates through the gas sealing filter;
a gas sealing layer, at least covering the exhaust vent and a part of the gas sealing filter; and
a sensing element, disposed in the housing.

2. The sensing device according to claim 1, further comprising:
a rigid support member, disposed between the housing and the gas sealing filter, wherein the rigid support member at least covers the exhaust vent, the rigid support member comprises at least one opening, the opening penetrates through the rigid support member, and the exhaust vent, the pass and the opening are in communication with one another.

3. The sensing device according to claim 2, wherein the gas sealing filter is disposed on the first surface of the housing.

4. The sensing device according to claim 3, wherein the rigid support member is disposed on the first surface of the housing.

5. The sensing device according to claim 2, wherein the gas sealing filter is disposed on the second surface of the housing.

6. The sensing device according to claim 5, wherein the rigid support member is disposed on the second surface of the housing.

7. The sensing device according to claim 1, wherein the sensing element is selected from a group consisting of a resonant magnetic field sensor, a resonator, a Radio Frequency (RF) switch, a micro bolometer and a gyroscope.

8. The sensing device according to claim 1, wherein the material of the gas sealing filter is selected from a group consisting of metal, ceramic and polymer.

9. The sensing device according to claim 1, wherein the exhaust vent is disposed at a top portion or a side wall of the housing.

10. The sensing device according to claim 1, wherein the housing comprises:
a first substrate; and
a second substrate, covering the first substrate, wherein at least one of the first substrate and the second substrate has a recessed portion, a chamber is formed through the recessed portion between the second substrate and the first substrate, the exhaust vent is disposed on at least one of the first substrate and the second substrate, and the sensing element is disposed in the chamber.

11. The sensing device according to claim 10, further comprising:
a rigid support member, disposed between the housing and the gas sealing filter, wherein the rigid support member at least covers the exhaust vent, the rigid support member comprises at least one opening, the opening penetrates through the rigid support member, and the exhaust vent, the pass and the opening are in communication with one another.

12. The sensing device according to claim 11, wherein the gas sealing filter is disposed on the first surface of the housing.

13. The sensing device according to claim 12, wherein the rigid support member is disposed on the first surface of the housing.

14. The sensing device according to claim 11, wherein the gas sealing filter is disposed on the second surface of the housing.

15. The sensing device according to claim 14, wherein the rigid support member is disposed on the second surface of the housing.

16. The sensing device according to claim 1, wherein the gas sealing layer at least covers a part of the pass, and a width of the pass is in a range of several nanometers to several hundred nanometers.

17. A fabricating method of a sensing device, comprising:
forming a sensing element on a first substrate;
forming an exhaust vent on a second substrate, wherein the exhaust vent penetrates through a first surface and a second surface of the second substrate;
forming a gas sealing filter on the second substrate, wherein the gas sealing filter comprises at least one pass having a section in the shape of an irregular curve, the pass penetrates through the gas sealing filter, and a width of the pass is in a range of several nanometers to several hundred nanometers;
bonding the second substrate on the first substrate, wherein the first substrate and/or the second substrate comprises a recessed portion, and a chamber is formed between the second substrate and the first substrate; and
forming a gas sealing layer on the second substrate to seal the chamber, wherein the gas sealing layer at least covers the exhaust vent, a part of the gas sealing filter and a part of the pass.

18. The fabricating method of a sensing device according to claim 17, further comprising:
forming a rigid support member between the second substrate and the gas sealing filter, wherein the rigid support member at least covers the exhaust vent, the rigid support member comprises at least one opening, the opening penetrates through the rigid support member, and the exhaust vent, the pass and the opening are in communication with one another.

19. The fabricating method of a sensing device according to claim 18, wherein the gas sealing filter is formed on the first surface of the second substrate.

20. The fabricating method of a sensing device according to claim 19, wherein the rigid support member is formed on the first surface of the second substrate.

21. The fabricating method of a sensing device according to claim 18, wherein the gas sealing filter is dispose on the second surface of the second substrate.

22. The fabricating method of a sensing device according to claim 21, wherein the rigid support member is dispose on the second surface of the second substrate.

23. The fabricating method of a sensing device according to claim 17, wherein the sensing element is a resonant magnetic field sensor, a resonator, a Radio Frequency (RF) switch, a micro bolometer, or a gyroscope.

24. The fabricating method of a sensing device according to claim 17, wherein the material of the gas sealing filter is one selected from a group consisting of metal, ceramic and polymer.

25. The fabricating method of a sensing device according to claim 17, wherein a fabricating method of the gas sealing filter comprises:
providing a bi-metal alloy; and
dealloying the bi-metal alloy.

26. The fabricating method of a sensing device according to claim 17, wherein a method for forming the gas sealing layer is selected from a group consisting of a physical vapor deposition and a chemical vapor deposition.
